(19) United States
(12) Patent Application Publication
(10) Pub. No.: US 2023/0067495 A1
(43) Pub. Date: Mar. 2, 2023

(54) Cast Net Blanket Device

(71) Applicant: Curtis Jennings, Hampton, VA (US)

(72) Inventor: Curtis Jennings, Hampton, VA (US)

(21) Appl. No.: 17/889,454

(22) Filed: Aug. 17, 2022

Related U.S. Application Data
(60) Provisional application No. 63/237,601, filed on Aug. 27, 2021.

(51) Int. Cl. A01K 75/00; A01K 75/06

(52) U.S. Cl. CPC A01K 75/005; A01K 75/06

(57) ABSTRACT

The present invention relates to a cast net blanket device primarily comprised of at least one base, at least two primary ropes, at least one secondary rope, at least one secondary rope fastener, and a first and second base fastener. During use, the primary ropes can be pulled upward, such that fish are contained within the device, and wherein the secondary ropes can be pulled upward to create two separate areas within the device. One area can store keeper fish, wherein the keeper fish can be easily transferred to a bucket underneath the area via the first base fastener that can be opened and the non-keeper fish can be release by lowering the side of the primary rope where unwanted fish are stored, which allows the blanket to unfold and fall back into the body of water it came from.

### CROSS-REFERENCE TO RELATED APPLICATION

The present application claims priority to, and the benefit of, U.S. Provisional Application No. 63/237,601, which was filed on Aug. 27, 2021, and is incorporated herein by reference in its entirety.

### FIELD OF THE INVENTION

The present invention relates generally to the field of fishing. More specifically, the present invention relates to a cast net blanket device primarily comprised of at least one base, at least two (but preferably four) primary ropes, at least one secondary rope, at least one secondary rope fastener, and a first and second base fastener. During use, the primary ropes can be pulled upward, such that fish are contained within the device, and wherein the secondary ropes can be pulled upward to create two separate areas within the device. One area can store keeper fish wherein the keeper fish can be easily transferred to a bucket underneath the area via the first base fastener that can be opened. Accordingly, the present disclosure makes specific reference thereto. Nonetheless, it is to be appreciated that aspects of the present invention are also equally applicable to other like applications, devices, and methods of manufacture.

### BACKGROUND

Fishermen often use a cast net or other traps to catch a large number of aquatic creatures simultaneously. Once said creatures are caught in a cast net, they then must be dumped from the net. Typically captured fish are unloaded onto sand, dirt, grass, and rocks which makes managing aquatic creatures difficult. Further, fishermen will spend a considerable amount of time collecting desired fish (“Keeper fish”) from the net and tossing unwanted fish back into the water one by one from the net. This process is inconvenient and inefficient. Further, because this process is time-consuming it may cause fish to become deceased due to prolonged time out of the water on environmental surfaces.

Therefore, there exists a long-felt need in the art for a novel device that can be used when separating fish from a cast net. There also exists a long-felt need in the art for a cast net blanket device that creates a secure area to collect fish removed from a cast net, while also maintaining a fast convenient method of releasing unwanted fish and retaining keeper fish. Further, there exists a long-felt need in the art for a cast net blanket device that allows a user to maintain control when placing keeper fish into keeper containers.

The subject matter disclosed and claimed herein, in one embodiment thereof, comprises a cast net blanket device. The device is primarily comprised of at least one base, at least two (but preferably four) primary ropes, at least one secondary rope, at least one secondary rope fastener, and a first and second base fastener. During use, the primary ropes can be pulled upward, such that fish are contained within the device. Then, the secondary ropes can be pulled upward to create two separate areas within the device. One area can store keeper fish, wherein the keeper fish can be easily transferred to a bucket or container underneath the area via the first base fastener which can be opened. Once all keeper fish are removed, the secondary ropes can be lengthened such that the base reverts to one area instead of two. The remaining fish can then be removed from the base via the second base fastener that can also be opened.

In this manner, the cast net blanket device of the present invention accomplishes all of the foregoing objectives and provides a novel device that can be used when separating fish from a cast net. Further, the device advantageously creates a secure area to collect fish removed from a cast net while maintaining a fast, convenient method of releasing unwanted fish and retaining keeper fish. In addition, the device allows a user to maintain control when placing keeper fish into keeper containers.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cast net blanket device. The device is primarily comprised of at least one base, at least two (but preferably four) primary ropes, at least one secondary rope at least one, secondary rope fastener, and a first and second base fastener. The base is preferably square in shape and is made from a water-resistant and/or waterproof nylon material. In the preferred square embodiment, the base has four corners wherein each corner is comprised with weights. The weight aids in adjusting the position of the base while separating fish and preventing the wind from moving the base.

Each corner is further comprised of at least one eyelet. The first end of the primary rope of each corner may be fixedly or removably attached within the corner and preferably exits the corner via each eyelet. Each primary rope is preferably made from a parachute cord material. The second end of each primary rope meets in the middle of the base and is secured to each other via at least one primary rope fastener that is preferably a metal collar. The primary rope fastener is further comprised of at least one loop.

The base is further comprised of at least one first base fastener and preferably a second base fastener. Both fasteners are preferably a zipper fastener. The first base fastener is preferably positioned in the middle of the base and the second base fastener is preferably positioned parallel to the first base fastener. The middle of the base may be comprised of at least one secondary rope, but preferably has a first secondary rope and a second secondary rope that meet at least one fastener. The fastener is preferably a locking fastener that allows both ropes to be shortened in length and locked at said shortened position.

To use the device, a user first pulls the loop upward which draws all four corners of the base upward. Then, fish and/or other aquatic animals can be dumped into the base from a cast net and are retained within the base. A user can then pull both secondary ropes upward and away from the base to shorten the ropes and secure the ropes at the shortened length via the fastener. This separates the base into two areas on either side of the ropes which allows a user to place keeper fish in one area and non-keeper fish in the other area. If all the aquatic creatures are being kept that are remove from the cast net. Users can pull the primary ropes upwards to enclose the fish. Then open the first base zipper fastener to deliver the captured fish in to their keeper container. When dividing fish, the keeper area is preferably the area with the second base fastener, wherein a user can place a container below the fastener such that the fastener can be unzipped and the keeper fish can be easily transferred from the base to a container below the base. Then, the secondary ropes can be lengthened such that the base no longer has two divided areas but instead returns to one area, wherein the first fastener can be opened to allow non-keeper fish to be released as needed. There is also an option to release fish by lowering the primary rope, which opens the side unwanted fish where separated on. Allowing them to fall out at the blankets end.

Accordingly, the cast net blanket device of the present invention is particularly advantageous as it provides a novel device that can be used when separating fish from a cast net. Further, the device advantageously creates a secure area to collect fish removed from a cast net. While doing so, the device maintains a fast, convenient method of releasing unwanted fish and retaining keeper fish. In addition, the device allows a user to maintain control when placing keeper fish into keeper containers. In this manner, the cast net blanket device provides a novel solution to a problem many fishermen face.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cast net blanket device of the present invention in accordance with the disclosed architecture;

FIG. 2 illustrates a perspective view of one potential embodiment of a cast net blanket device of the present invention while being used in accordance with the disclosed architecture; and

FIG. 3 illustrates a flowchart of one potential method of using one potential embodiment of a cast net blanket device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a novel device that can be used when separating fish from a cast net. There also exists a long-felt need in the art for a cast net blanket device that creates a secure area to collect fish removed from a cast net, while maintaining a fast, convenient method of releasing unwanted fish and retaining keeper fish. Further, there exists a long-felt need in the art for a cast net blanket device that allows a user to maintain control when placing keeper fish into keeper containers.

The present invention, in one exemplary embodiment, is comprised of a cast net blanket device primarily comprised of at least one base, at least two (but preferably four) primary ropes, at least one secondary rope, at least one secondary rope fastener, and a first and second base fastener. The base is preferably square in shape. The base is also preferably made from a water-resistant and/or waterproof nylon material. In the preferred square embodiment, the base has four corners. Each corner may be comprised of weights. The weight aids in adjusting the position of the base while separating fish and preventing the wind from moving the base.

Each corner is further comprised of at least one eyelet, wherein the first end of the primary rope of each corner may be fixedly or removably attached within the corner and preferably exits the corner via each eyelet. Each primary rope is preferably made from a parachute cord material. The second end of each primary rope meets in the middle of the base. Each second end is secured to each other via at least one primary rope fastener that is preferably a metal collar. The primary rope fastener is further comprised of at least one loop.

The base is further comprised of at least one first base fastener and preferably a second base fastener, wherein both fasteners are preferably a zipper fastener. The first base fastener is preferably positioned in the middle of the base and the second base fastener is preferably positioned parallel to the first base fastener. The middle of the base may be comprised of at least one secondary rope, but preferably has a first secondary rope and a second secondary rope that meet at least one fastener. The fastener is preferably a locking fastener that allows both ropes to be shortened in length and locked at said shortened position.

To use the device, a user must lay the product flat on the surface of choice. Then, fish and/or other aquatic animals can be dumped into the base from a cast net and are retained within the base for separation. First pulls the loop upward which draws all four corners of the base upward. A user can then pull both secondary ropes upward and away from the base. This shortens the ropes, wherein the ropes can then be secured at the shortened length via the fastener. This divides the base into two areas on either side of the ropes which allows a user to place keeper fish in one area and non-keeper fish in the other area. The keeper area is preferably the area with the second base fastener, wherein a user can place a container below the fastener such that the fastener can be unzipped and keeper fish can be easily transferred from the base to the container. Then, the secondary ropes can be lengthened such that the base no longer has two divided areas but instead returns to one area, wherein the first fastener can be opened to allow non-keeper fish to be released as needed or the user can lower the end of the rope the non-keeper fish are on. Which allows the fish to be released of the end of the blanket end once it folds down.

Accordingly, the cast net blanket device of the present invention is particularly advantageous as it provides a novel device that can be used when separating fish from a cast net. Further, the device advantageously creates a secure area to collect fish removed from a cast net. While doing so, the device maintains a fast, convenient method of releasing unwanted fish and retaining keeper fish. In addition, the device allows a user to maintain control when placing keeper fish into keeper containers. In this manner, the cast net blanket device provides a novel solution to a problem many fishers face.

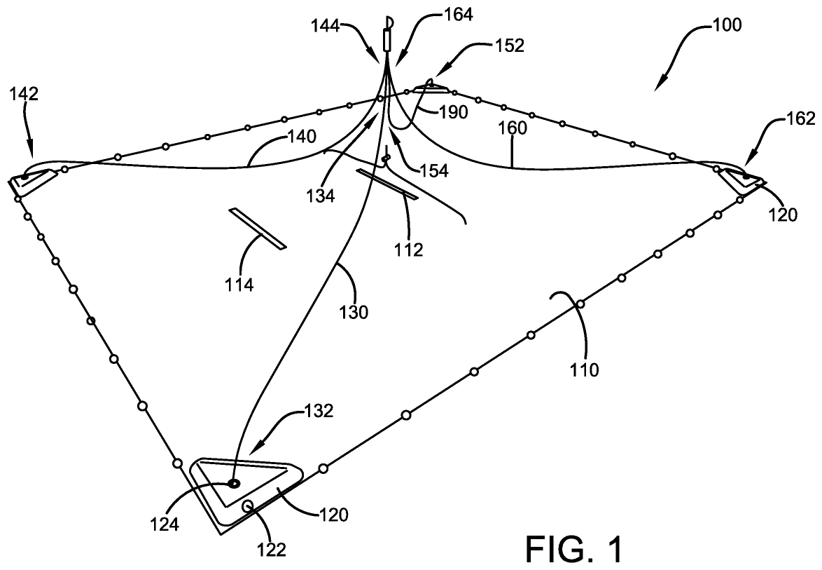

Referring initially to the drawings, FIG. 1 illustrates a perspective view of one potential embodiment of a cast net blanket device 100 of the present invention in accordance with the disclosed architecture. The device 100 is primarily comprised of at least one base 110, at least two (but preferably four) primary ropes 130, 140, 150, 160, at least one secondary rope 200, 210, at least one secondary rope fastener 220, and a first and second base fastener 112, 114. The base 110 is preferably square in shape but may be any shape known in the art in differing embodiments such as, but not limited to, rectangular, circular, triangular, etc. The base 110 is preferably made from a water-resistant and/or waterproof nylon material. The base 110 may be any size in differing embodiments.

In the preferred square embodiment, the base 110 has four corners 120. Each corner 120 may be comprised of weights 122 Additionally, or alternatively, any portion of the base 110 may comprised of weights 122. This includes, but is not limited to, the perimeter of the base 110, within the material of the base 110, etc. The weight 122 may be any amount of weight but is preferably a six-ounce weight. The weight 122 is preferably fixedly attached to or within each corner 120 via a fastening method such as, but not limited to, sewing. The weight 122 aids in adjusting the position of the base 110 while separating fish and preventing the wind from moving the base 110.

Each corner 120 is further comprised of at least one eyelet 124. The eyelet 124 is preferably made from stainless steel or other durable metal material. The first end 132, 142, 152, 162 of the primary rope 130, 140, 150, 160 of each corner 120 may be fixedly or removably attached within the corner 120 and preferably exits the corner 120 via each eyelet 124. Each primary rope 130, 140, 150, 160 is preferably made from a parachute cord material, but may be made from any rope material in the art such as, but not limited to, a natural rope, a synthetic rope, a single braid rope, a plaited rope, a twisted rope, a double braid rope, a hollow rope, a manila rope, a polypropylene rope, a nylon rope, a bungee shock cord, etc.

The second end 134, 144, 154, 164 of each primary rope 130, 140, 150, 160 meets in the middle of the base 110 and is secured to each other via at least one primary rope fastener 170 that is preferably a metal collar or other fastening means known in the art. The primary rope fastener 170 is further comprised of at least one loop 172 that may be made from a durable metal, plastic, or rope material that allows the device 100 to be hung if needed during use.

The base 110 is further comprised of at least one first base fastener 112 and preferably a second base fastener 114. Both fasteners 112, 114 are preferably a zipper fastener, but may be any fastener type known in the art such as, but not limited to, snap-button, hook and loop, magnet, ties, clasps, etc. The first base fastener 112 is preferably positioned in the middle of the base 110. The second base fastener 114 is preferably positioned parallel to the first base fastener 112.

The middle of the base 110 may be comprised of at least one secondary rope 200, but preferably has a first secondary rope 200 and a second secondary rope 210 that meet at least one fastener 220. The fastener 220 is preferably a locking fastener that allows both ropes 200, 210 to be shortened in length and locked at said shortened position.

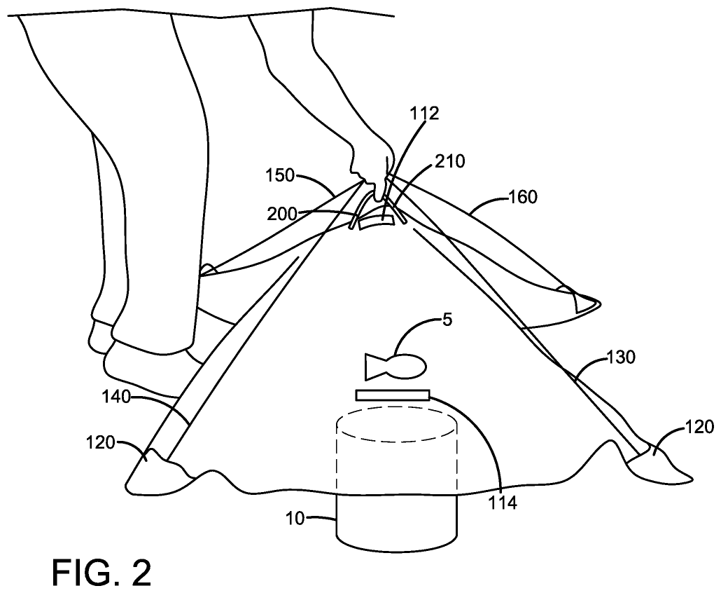

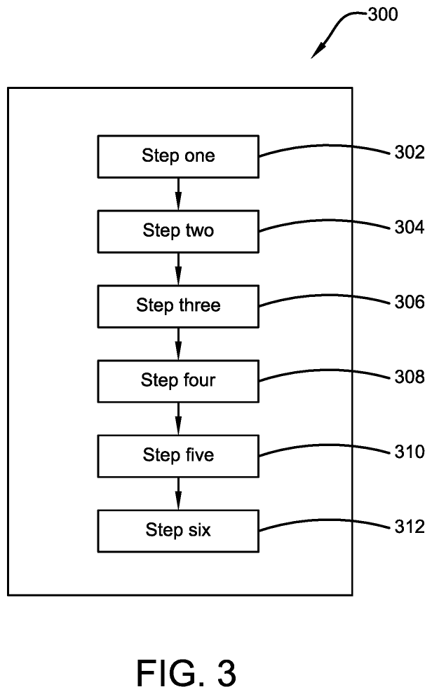

FIG. 3 illustrates a flowchart of one potential method 300 of using one potential embodiment of a cast net blanket device 100 of the present invention in accordance with the disclosed architecture. The device 100 is also comprised of a method of use 300. First, a user pulls the loop 172 (or each rope 130, 140, 150, 160) upward [Step 302]. This draws all four corners 120 of the base 110 upward. At this point, at least one fish 5 or other aquatic animal can be dumped into the base 110 from a cast net or other containment area [Step 304]. Because of the raised position of the corners 120 (that form a generally bucket-like area with raised corners 120), the fish are retained in the base 110. A user can then pull both secondary ropes 200, 210 upward and away from the base 110 to shorten the ropes and secure the ropes 200, 210 at the shortened length via the fastener 220 [Step 306]. As a result, the base 110 becomes separated into two areas on either side of the ropes 200, 210 as seen in FIG. 2. This allows a user to place keeper fish in one area and non-keeper fish in the other area. The keeper area is preferably the area with the second base fastener 114. In this manner, a user can place a container 10 or other device below the fastener 114 such that the fastener 114 can be unzipped and keeper fish can be easily transferred from the base 110 to the container 10 to be stored [Step 308]. Then, the ropes 200, 210 can be lengthened such that the base 110 no longer has two divided areas but instead returns to one area [Step 310]. Then, the first fastener 112 can be opened to allow non-keeper fish to be released as needed [Step 312], or the user can lower the end of the rope the non-keeper fish are on. Which allows the fish to be released off the end of the blanket end once it folds down.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cast net blanket device” and “device” are interchangeable and refer to the cast net blanket device 100 of the present invention.

Notwithstanding the foregoing, the cast net blanket device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cast net blanket device 100 as shown in the FIGS. are for illustrative purposes only, and that many other sizes and shapes of the cast net blanket device 100 are well within the scope of the present disclosure. Although the dimensions of the cast net blanket device 100 are important design parameters for user convenience, the cast net blanket device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cast net blanket device comprising:
a base;
a first base fastener;
a second base fastener;
a weight;
a first primary rope;
a second primary rope; and
a first secondary rope comprised of a first secondary rope fastener.

2. The cast net blanket device of claim 1, wherein the base is comprised of a waterproof nylon material.

3. The cast net blanket device of claim 1, wherein the base is square.

4. The cast net blanket device of claim 1, wherein the first primary rope and the second primary rope are comprised of a parachute cord material.

5. A cast net blanket device comprising:
a square base comprised of a first corner, a second corner, a third corner and a fourth corner;
a first base fastener;
a second base fastener;
a weight;
a first primary rope;
a second primary rope;
a third primary rope;
a fourth primary rope;
a first secondary rope;
a second secondary rope; and
a secondary rope fastener.

6. The cast net blanket device of claim 5, wherein the base is comprised of a water-resistant nylon material.

7. The cast net blanket device of claim 5, wherein each of the first corner, the second corner, the third corner and the fourth corner is reinforced with a rigid plastic material.

8. The cast net blanket device of claim 5, wherein the weight is a six-ounce weight.

9. The cast net blanket device of claim 5, wherein the weight is positioned at the first corner, the second corner, the third corner or the fourth corner.

10. The cast net blanket device of claim 6, wherein the weight is positioned within the water-resistant nylon material of the base.

11. The cast net blanket device of claim 5, wherein a first end of the first primary rope attaches to the first corner, a first end of the second primary rope attaches to the second corner, a first end of the third primary rope attaches to the third corner, and a first end of the fourth primary rope attaches to the fourth corner.

12. The cast net blanket device of claim 5, wherein a second end of the first primary rope, a second end of the second primary rope, a second end of the third primary rope, and a second end of the fourth primary rope are attached via a primary rope fastener.

13. The cast net blanket device of claim 12, wherein the primary rope fastener is comprised of a loop.

14. The cast net blanket device of claim 5, wherein the first secondary rope and the second secondary rope converge at the secondary rope fastener.

15. The cast net blanket device of claim 14, wherein the secondary rope fastener is a locking fastener.

16. The cast net blanket device of claim 5, wherein the first corner is comprised of a first eyelet, the second corner is comprised of a second eyelet, the third corner is comprised of a third eyelet, and the fourth corner is comprised of a fourth eyelet.

17. The cast net blanket device of claim 5, wherein the first base fastener and the second base fastener are a zipper fastener, a hook and loop fastener, a magnet fastener, or a snap-button fastener.

18. The cast net blanket device of claim 17, wherein the first base fastener is positioned in a middle area of the base.

19. The cast net blanket device of claim 18, wherein the second base fastener is parallel with the first base fastener.

20. A method of using a cast net blanket device, the method comprising the steps of:
placing a fish on the base;
pulling a first primary rope, a second primary rope, a third primary rope, and a fourth primary rope of the cast net blanket device upwards away from a base of the cast net blanket device;
pulling a first secondary rope and a second secondary rope of the cast net blanket device upwards away from the base;
locking the first secondary rope and the second secondary rope into a shortened position relative to and by using a secondary rope fastener;
moving the fish to a first area or a second area of the base that was created by the shortening of the first secondary rope and the second secondary rope; and
opening a first base fastener to release the fish from the base into a container below the first base fastener after lengthening the first secondary rope and the second secondary rope relative to and by using a secondary rope fastener or;
opening the second base fastener to release the fish from the base into a container below the second base fastener after lengthening the first secondary rope and the second secondary rope relative to and by using a secondary rope fastener.
